(19) United States
(12) Patent Application Publication
(10) Pub. No.: US 2025/0042373 A1
(43) Pub. Date: Feb. 6, 2025

(54) SYSTEM AND METHOD FOR AUTOMATIC CONTROL OF VEHICLE TURN ASSIST FEATURE

(71) Applicant: FORD GLOBAL TECHNOLOGIES, LLC, Dearborn, MI (US)

(72) Inventors: Zubair Feroz, Dearborn, MI (US); Bang Kim Cao, Northville, MI (US)

(21) Appl. No.: 18/230,390

(22) Filed: Aug. 4, 2023

(51) Int. Cl. B60T 8/24

(52) U.S. Cl. CPC B60T 8/246; B60T 2201/16; B60T 2210/12; B60T 2220/00; B60T 2250/04

(57) ABSTRACT

A vehicle control system may include a mode selector including at least a turn assist mode selectable by an operator of the vehicle to activate a turn assist feature, a controller to employ the turn assist feature by directing application of braking torque to an inside rear wheel of the vehicle during a turn when a trigger condition for implementing the turn assist feature may be detected, and a mu detection module to estimate mu conditions of a surface on which the vehicle may be operating. The controller may further automatically generate a blocking signal to block operation of the turn assist feature responsive to the mu detection module estimating a minimum mu value of the surface that may be less than a threshold mu value.

### TECHNICAL FIELD

Example embodiments generally relate to vehicle control technology and, more particularly, relate to a system and method for activating a reduced turning radius feature of the vehicle.

### BACKGROUND

Vehicles with a relatively long wheelbase, such as trucks, often also have large turning radiuses. This can make such vehicles difficult to park or maneuver in relatively tight spaces. Such vehicles may also struggle to complete a U-turn in certain situations. Larger front wheel drive vehicles may also face similar issues. Thus, a turning radius reduction feature may be implemented to provide a more satisfying user experience for drivers of these and other vehicles.

However, it may not be advantageous to activate the turning radius reduction feature in certain driving conditions. Accordingly, it may be desirable to develop a system and method for automatically controlling the turning radius reduction feature to provide a more satisfying user experience for drivers of these and other vehicles.

### BRIEF SUMMARY OF SOME EXAMPLES

In accordance with an example embodiment, a vehicle control system for a vehicle may be provided. The vehicle control system may include a mode selector including at least a turn assist mode selectable by an operator of the vehicle to activate a turn assist feature, a controller to employ the turn assist feature by directing application of braking torque to an inside rear wheel of the vehicle during a turn when a trigger condition for implementing the turn assist feature may be detected, and a mu detection module to estimate mu conditions of a surface on which the vehicle may be operating. The controller may further automatically generate a blocking signal to block operation of the turn assist feature responsive to the mu detection module estimating a minimum mu value of the surface that may be less than a threshold mu value.

In another example embodiment, a method of automatically controlling application of a turn assist feature in a vehicle is provided. The method may include estimating mu conditions of a surface on which the vehicle may be operating via a mu detection module, receiving a mode selection selecting a turn assist mode, receiving steering wheel angle and vehicle speed information to determine if a trigger condition for implementing the turn assist feature may be met during a turn, in response to the trigger condition for implementing the turn assist feature being detected, applying a negative torque to an inside rear wheel, and automatically generating a blocking signal to block operation of the turn assist feature responsive to the mu detection module estimating a minimum mu value of the surface that may be less than a threshold mu value.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a block diagram of a vehicle control system in accordance with an example embodiment;

FIG. 2 illustrates a block diagram of some components of the vehicle control system of FIG. 1 in accordance with an example embodiment;

FIG. 3 illustrates a block diagram of a vehicle control system in accordance with an example embodiment;

FIG. 4 illustrates a decision making flowchart of the controller according to an example embodiment;

FIG. 5 illustrates a decision making flowchart of the controller according to an example embodiment; and

FIG. 6 illustrates a method of controlling a vehicle in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

As noted above, it may be desirable to develop a system and method for automatically controlling the turning radius reduction feature. That said, strategies that may work in a large vehicle context may also work for other vehicles. Thus, example embodiments are not strictly limited to application in large vehicles.

It may be possible to use brake torque to assist in turning radius reduction via what is often referred to as brake-steer, or brake-assisted turning. However, it may be desirable to provide a system capable of improving the performance of brake-steer or brake-assisted turning. Example embodiments may provide such improvement by enabling strategic control of both positive and negative torque applied to the wheels of front and rear axles during a turn. By applying a negative torque to the rear inside wheel during a turn, and applying positive torque to the front wheels to pull the vehicle through the turn, not only can the vehicle turning radius be reduced, but the user experience during the application of the turning radius reduction may also be smoother. However, such a turn assist feature may only be desirable in driving conditions with sufficient grip with the driving surface. In conditions with low grip, the turn assist feature should be deactivated or prevented entirely. Example embodiments may provide strategic control of the turn assist feature based on automatic calculations of mu conditions of the surface on which the vehicle may operate.

Some example embodiments may therefore provide a system that is not only capable of providing a turn assist feature to reduce turning radius in an automatic fashion that is seamless for the driver, but also monitoring the operating conditions of the driving surface and automatically generating a blocking signal to block operation of the turn assist feature responsive to detecting a slippery driving surface. In this regard, for example, a controller of the system of example embodiments may be configured to automatically apply negative torque to a rear inside wheel during a tight turn, and apply positive torque to front wheels. The application of such balanced torque may, in some cases, be determined based on or otherwise incorporate or consider wheel slip, which is a measure of the difference in speed between certain wheels. For example, wheel slip may be determined for the rear inside wheel, and may be controlled during application of the turning radius reduction strategy. The controller may also use wheel slip to detect a loss or a reduction of friction between the wheels and the surface, and automatically control the turn assist feature accordingly.

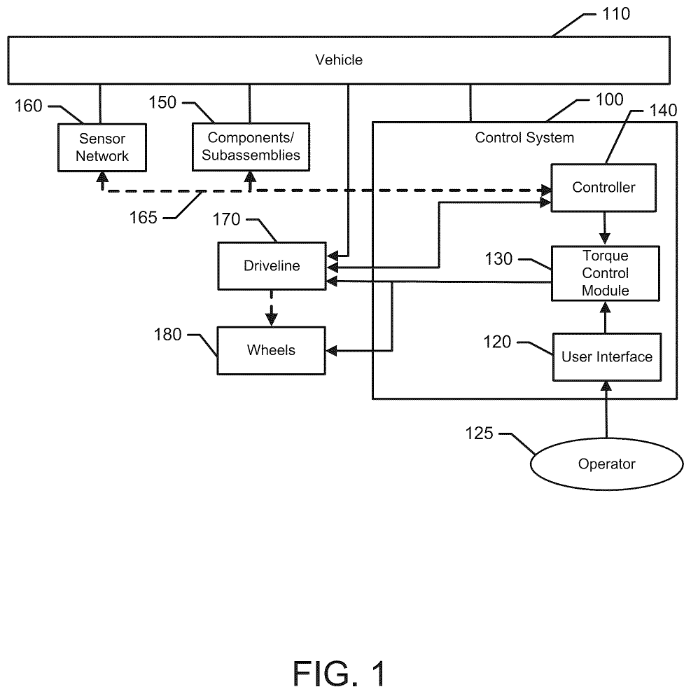

FIG. 1 illustrates a block diagram of a control system 100 of an example embodiment. The components of the control system 100 may be incorporated into a vehicle 110 (e.g., via being operably coupled to a chassis of the vehicle 110, various components of the vehicle 110 and/or electronic control systems of the vehicle 110). Of note, although the components of FIG. 1 may be operably coupled to the vehicle 110, it should be appreciated that such connection may be either direct or indirect. Moreover, some of the components of the control system 100 may be connected to the vehicle 110 via intermediate connections to other components either of the chassis or of other electronic and/or mechanical systems or components.

The control system 100 may have a normal mode of operation that includes an input device in the form of control pedals and the steering wheel (or hand wheel). The pedals may include a brake pedal and an accelerator pedal pivotally mounted to the floor of the vehicle 110, and operable by an operator 125. The brake pedal may generally be used to provide inputs for control of braking torque, and the accelerator pedal may be used to provide inputs for control of propulsive torque. However, the normal mode of operation may not be desirable for all cases. Moreover, selectable other modes of operation, including one or more off-road driver assistance modes, parking modes, turn assist modes, etc., may also exist. Accordingly, the control system 100 of some example embodiments may further include a user interface 120. The operator 125 may operate the user interface 120, which may include or define a mode selector to shift out of the normal mode of operation and into any of the other modes of operation. In one example embodiment, the other modes of operation that can be selected by the operator 125 via the user interface 120 may include a turn assist mode, in which turn radius reduction may be initiated as described in greater detail below.

Of note, although the term turn assist mode will generally be referred to herein as being the mode in which example embodiments are performed, the name of the mode in which example embodiments may be applied is not important, and certainly not limiting. As noted above, other terms like brake-steering mode, parking mode, or any other mode in which the functionality described herein is applied, are also possible.

The control system 100 of example embodiments may also include the torque control module 130, which may be part of or otherwise operably coupled to a controller 140. The torque control module 130 may be configured to determine positive torque (e.g., propulsive torque) and/or negative torque (e.g., brake torque, regenerative torque, etc.) to be applied to the wheels, individually, in pairs or collectively (e.g., depending on driveline state and/or vehicle type) as described herein based on inputs from any or all of the controller 140, the user interface 120 or other components of the vehicle 110. In some cases, the controller 140 may be part of an electronic control system of the vehicle 110 that is configured to perform other tasks related or not related to propulsive and braking control or performance management. However, the controller 140 could be a dedicated or standalone controller in some cases.

In an example embodiment, the controller 140 may receive information that is used to determine vehicle status from various components or subassemblies 150 of the vehicle 110. Additionally or alternatively, various sensors that may be operably coupled to the components or subassemblies 150 may be included, and may provide input to the controller 140 that is used in determining vehicle status. Such sensors may be part of a sensor network 160 and sensors of the sensor network 160 may be operably coupled to the controller 140 (and/or the components or subassemblies 150) via a vehicle communication bus (e.g., a controller area network (CAN) bus) 165.

The components or subassemblies 150 may include, for example, the steering wheel of the vehicle, a brake assembly, a propulsion system and/or a wheel assembly of the vehicle 110. The brake assembly may be configured to provide braking inputs to braking components of the vehicle 110 (e.g., friction brakes and electrical methods of braking such as regenerative braking) based on a braking torque determined by the controller 140 and/or torque control module 130. In some cases, the brake assembly may include an electric brake boost (EBB) system, which uses electric brake boosters to sense driver input and reduce the amount of pedal pressure needed for braking. The propulsion system may include a gas engine, electric motor, or any other suitable propulsion device.

The controller 140 and/or torque control module 130 may be configured to determine positive and negative torque inputs for provision to components of a driveline 170 (e.g., driveshaft, differential(s), axle shaft(s), etc.) and wheels 180 of the vehicle 110. Thus, for example, the torque control module 130 may determine positive torque inputs for provision to the propulsion system to apply propulsive torque to the wheels 180 of the wheel assembly of the vehicle 110 via the driveline 170, and determine negative torque inputs for provision to the wheels 180 in the form of braking torque, regenerative torque, or the like. Moreover, one or more corresponding sensors of the sensor network 160 that may be operably coupled to the brake assembly and/or the wheel assembly may provide information relating to brake torque, brake torque rate, vehicle velocity, vehicle rate of change of speed, individual wheel speeds, front/rear wheel speeds, vehicle pitch, etc. Other examples of the components or subassemblies 150 and/or corresponding sensors of the sensor network 160 may provide information relating to yaw, lateral G force, steering wheel angle, throttle position, selector button positions associated with chassis and/or vehicle control selections, etc.

Accordingly, for example, the controller 140 may be able to receive numerous different parameters, indications and other information that may be related to or indicative of different situations or conditions associated with vehicle status. The controller 140 may also receive information indicative of the intent of the operator 125 (e.g., based on mode selection, steering wheel angle, speed, etc.) relative to control of various aspects of operation of the vehicle 110 and then be configured to use the information received in association with the execution of one or more control algorithms that may be used to provide instructions to the torque control module 130 in order to control application of positive and negative torque to the wheels of the wheel assembly of the vehicle 110.

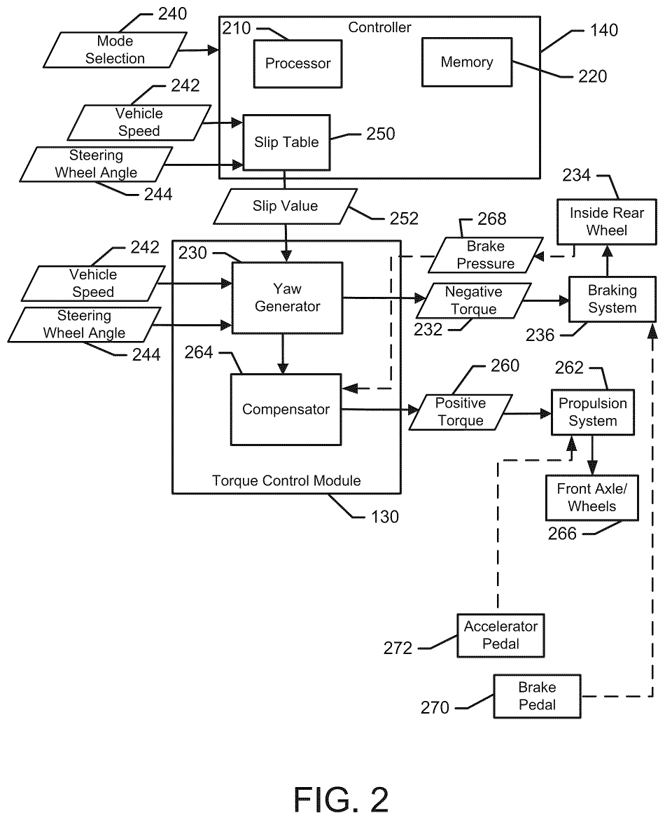

In an example embodiment, the operator 125 may use the user interface 120 to select the turn assist mode. The user interface 120 may be embodied by an interactive display in the vehicle 110, and may therefore be a soft switch provided on the display. However, in other examples, the user interface 120 may include a hard switch, a button, key, or other selectable operator located in the cockpit of the vehicle 110. Selection of the turn assist mode may correspondingly activate the torque control module 130 to provide the automated turning control described herein based on information provided by the components or subassemblies 150 and/or corresponding sensors of the sensor network 160. More specifically, selection of the turn assist mode may enable control of turning capabilities based on vehicle speed, steering wheel position, and a control of negative torque to an inner rear wheel, while providing a feed forward offsetting positive torque to the front wheels. Operation of the torque control module 130 will be described in greater detail below in reference to FIG. 2.

As noted above, when the torque control module 130 is active, and automated turning controls have been activated, outputs of the torque control module 130 may be provided to components of the driveline 170 of the vehicle 110. The controller 140 may therefore receive information to enable the controller 140 to determine a state of the driveline 170 of the vehicle 110, or the specific driveline 170 characteristics for the type of vehicle involved may be programmed into the algorithms that are executable by the controller 140. The driveline 170 may include front and rear axles and various drive components for the front and rear axles and/or the components that provide coupling therebetween. Thus, for example, the driveline 170 may include a differential (e.g., a front differential for a front wheel drive vehicle) and gears and/or clutch components that operably couple the front and rear axles (and/or their driving components). In some examples, such as when the vehicle 110 is a battery electric vehicle (BEV), the driveline 170 may include individual electric motors for either each axle or even each wheel.

Referring now to FIG. 2, operation of the controller 140 and the torque control module 130 will be described in greater detail. FIG. 2 illustrates a block diagram of various components of the control system 100 in greater detail. In this regard, for example, FIG. 2 illustrates example interactions between the controller 140 and the torque control module 130 relative to information received thereby (e.g., from the sensor network 160, from various ones of the components/subassemblies 150, and/or from the user interface 120). Processing circuitry (e.g., a processor 210 and memory 220) at the controller 140 may process the information received by running one or more control algorithms. The control algorithms may include instructions that can be stored by the memory 220 for retrieval and execution by the processor 210. In some cases, the memory 220 may further store one or more tables (e.g., look up tables) and various calculations and/or applications may be executed using information in the tables and/or the information as described herein.

The processor 210 may be configured to execute the control algorithms in series or in parallel. However, in an example embodiment, the processor 210 may be configured to execute multiple control algorithms in parallel (e.g., simultaneously) and substantially in real time. The control algorithms may be configured to perform various calculations based on the information received/generated regarding specific conditions of vehicle components. The control algorithms may therefore execute various functions based on the information received, and generate outputs to drive the control of torque applied at the wheels of the vehicle 110 (e.g., individually or in pairs). The torque control module 130 may itself be a control algorithm, or may include control algorithms in the form of functional modules (or sub-modules) configured to perform specific functions for which they are configured relating to control of the vehicle 110 in the manner described herein. Thus, for example, the controller 140 may actually function as the torque control module 130 responsive to executing the control algorithms. However, in other cases, the torque control module 130 may be a component or module of the controller 140, or an entirely separate component (e.g., including its own corresponding processing circuitry).

In an example embodiment, the torque control module 130 may include a turn enhancer or yaw generator 230 that defines a negative torque value 232 for application to an inside rear wheel 234 (e.g., via a braking system 236 of the vehicle 110) to generate increased yaw for the vehicle 110 during a turn. The yaw generator 230 may be configured to generate the negative torque value 232 only when a mode selection 240 has been made to place the vehicle 110 (e.g., via its controller 140) in the turn assist mode (or other similar mode), and when certain other qualifying conditions have been met (e.g., a trigger event or trigger condition). For example, the yaw generator 230 may further receive inputs including vehicle speed 242 and steering wheel angle 244. The turn assist mode may, for example, only be operable below a certain or threshold speed (e.g., below 12 miles per hour (mph), or another suitable speed value). Moreover, in some cases, the turn assist mode may only be operable (and therefore the yaw generator 230 only active), when a turn of sufficient magnitude (at the low speed defined by the threshold value for vehicle speed 242). For example, the yaw generator 230 may only operate when the steering wheel has been turned to a maximum extent (or to a predetermined angle proximate to the maximum angle) in one direction or the other. Thus, the steering wheel angle 244 and the vehicle speed 242 may only be enabling factors or trigger criteria in some cases for operation of the yaw generator 230. However, in other cases, the yaw generator 230 may generate the negative torque value 232 based on one or both of the vehicle speed 242 and the steering wheel angle 244. Thus, for example, a table of torque values may be indexed to corresponding vehicle speed 242 and/or steering wheel angle 244 values to determine the amount of the negative torque value 232.

In some embodiments, alternatively or additionally, the negative torque value 232 may be generated may be generated based on additional or other criteria. For example, a slip table 250 may be provided in some cases in order to generate a slip value 252. The slip table 250 may include a series of output values that are determined based on respective input values. Based on the respective input values, the slip table 250 may be referenced in order to determine the slip value 252. As shown in FIG. 2, the slip table 250 may consider the vehicle speed 242 and/or the steering wheel angle 244 in order to determine the slip value 252. The slip value 252 itself may be defined at a value that is just below a peak tire coefficient of friction (which may be referred to as tire Mu). In such examples, if the turn assist mode is selected, if the vehicle speed 242 is below the threshold speed (e.g., 12 mph) and the steering wheel is turned to maximum angle for a given period of time (e.g., held at lock, thereby indicating that the driver is providing steering torque to hold the wheel against the end stop for at least the given period of time), then the slip value 252 may be used by the yaw generator 230 to define the negative torque value 232 to be applied to the inside rear wheel 234.

Since the application of the negative torque value 232 to the inside rear wheel 234 will increase the yaw rate of the vehicle 110 during the turn in progress, the turn radius of the vehicle 110 may be decreased, as desired. However, the provision of the negative torque value 232 (e.g., via regenerative braking or applying friction braking to the inside rear wheel 234 only), will tend to slow the vehicle 110 during the resulting turn, the slowing sensation is felt by the driver, and therefore makes the feeling of the turn less seamless. To generate a more seamless turn, example embodiments may provide a positive torque value 260 to a propulsion system 262 of the vehicle 110 via a compensator 264. The compensator 264 may be configured to generate a feed forward torque value to offset the negative torque value 232 to thereby make the turn more seamless. The positive torque value 260 may be provided to the propulsion system 262 to apply power, for example, to the front axle or front wheels 266 of the vehicle 110. Thus, for example, the front wheels 266 of the vehicle 110 may pull the vehicle 110 through the turn while the inside rear wheel 234 has a negative torque applied thereto to increase the yaw rate that can be generated, and thereby also increase the turn rate while eliminating any noticeable change in speed during the turn.

In an example embodiment, the compensator 264 may receive an input value indicative of an amount of negative torque actually applied at the inside rear wheel 234. For example, the compensator 264 may receive an indication of brake pressure 268 being applied at the inside rear wheel 234. The positive torque value 260 generated by the compensator 264 may therefore be proportional to the brake pressure 268 being exerted at the inside rear wheel 234. Thus, the positive torque value 260 and the negative torque value 232 may not be set to be equal values, but instead, the positive torque value 260 may be set for a given situation as a value that tends to make the slow down generated by the negative torque value 232 less noticeable while still increasing the rate of the turn (e.g., via increasing the yaw rate of the vehicle 110). However, in examples in which each of the front wheels 266 has an individual electric motor (e.g., in the case of some BEVs), the ratio could be set at a one to one ratio. Otherwise, for example, if the brake pressure is 1000 Nm, the amount of the positive torque value 260 may be lower than 1000 Nm.

As shown in FIG. 2, a brake pedal 270 of the vehicle 110 may be used to provide braking inputs to the braking system 236 (but to both wheels), and an accelerator pedal 272 may be used to provide propulsive inputs to the propulsion system 262 of the vehicle 110. These inputs may exist in addition to the inputs that are automatically provided by the torque control module 130 described herein. Thus, to the extent the driver operates either or both of the brake pedal 270 and the accelerator pedal 272, the torque control module 130 may provide its automatic modifications to positive and negative torque in an additive manner with manual inputs, while also being responsive to the changes made via manual inputs by the driver.

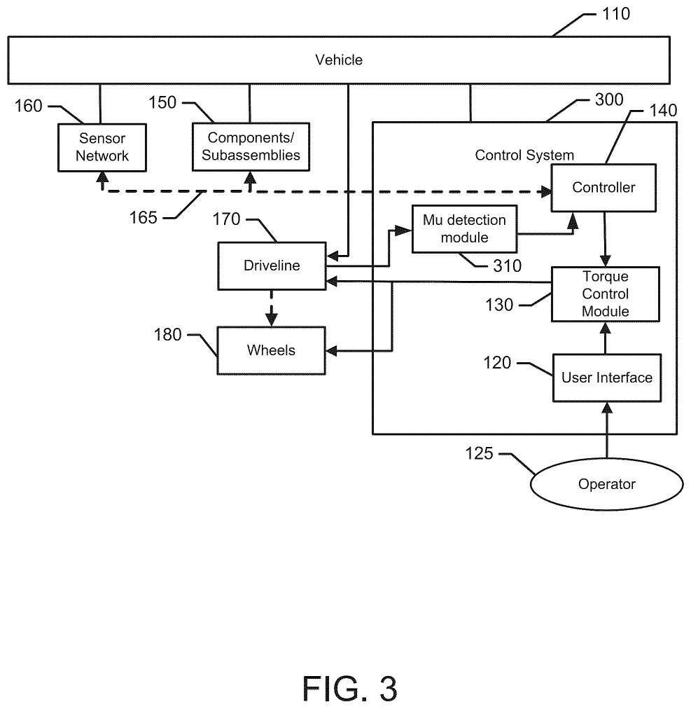

FIG. 3 depicts an embodiment of the vehicle control system 300 in which the control system 300 may include a mu detection module 310. The mu detection module 310 may estimate mu conditions of the surface on which the vehicle 110 may be operating, both while the turn assist feature may be active and while the turn assist feature may not be active. Thus, in some cases, the tire Mu mentioned above may be calculated continuously as the vehicle 110 is operated by the mu detection module 310, and the controller 140 may thus be aware of the mu estimate if any wheel has slipped in the past as well. The calculation of the tire Mu in an example embodiment may be an estimation of the tire Mu based on several factors, rather than a direct measurement of a coefficient of friction. In this regard, say for example the vehicle 110 is a BEV. The driveline 170 may therefore include an electric motor or electric motors which may be operably coupled to, or may include therein, the mu detection module 310. The mu detection module 310 may estimate the coefficient of friction (i.e. mu) between respective ones of the wheels 180 of the vehicle 110 and the surface on which the vehicle 110 is operating. The mu estimate of an example embodiment may be based on an amount of torque (positive or negative) delivered to a particular wheel via the driveline 170 or brakes (friction brakes or regenerative brakes) at the precise point in time when wheel slip may be detected at the particular wheel. In other words, the mu estimate value may be a function of the torque applied to the wheel. Thus the mu detection module 310 may not directly measure the coefficient of friction of the driving surface, but instead may calculate the mu estimate value based on known inputs to the wheel.

The mu detection module 310 may share the mu estimate with the controller 140, which, as discussed in detail above, may employ a turn assist feature by directing application of braking torque to an inside rear wheel of the vehicle 110 during a turn when a trigger condition for implementing the turn assist feature is detected. In some cases, the controller 140 may also automatically generate a blocking signal to block operation of the turn assist feature responsive to the mu detection module 310 estimating a minimum mu value that is less than a threshold mu value. This would indicate that one or more wheels 180 of the vehicle 110 may be operating on a slippery surface. In this regard, during low mu driving conditions (e.g. driving on slippery surfaces such as in snowy or icy conditions), it may not be advantageous for the operator 125 of the vehicle 110 to have the vehicle 110 automatically engage the turn assist feature responsive to detecting the trigger condition. The turn assist feature may temporarily exclusively apply power to the front wheels 266, as described above, which may therefore disable any all-wheel drive capability of the vehicle 110, effectively altering the vehicle 110 to become temporarily front wheel drive. Importantly, all-wheel drive capability may be more advantageous for the operator 125 in low mu driving conditions than the turn assist feature, and thus it may be desirable to automatically generate a blocking signal to block operation of the turn assist feature responsive to the mu detection module 310 estimating a minimum mu value of the surface that is less than a threshold mu value, that may indicate slippery driving surfaces.

As mentioned above, the mu detection module 310 may estimate mu conditions of the surface on which the vehicle 110 may be operating, both while the turn assist feature may be active and while the turn assist feature may not be active. An algorithm contained in the memory 220 of the controller 140 for detecting low mu conditions may thus be both predictive and reactive: predictive in the sense that the turn assist feature may not be activated if low mu conditions are detected, and reactive in the sense that the turn assist feature may be deactivated or terminated if it is currently active when low mu conditions are detected. In some example embodiments, detecting low mu conditions may occur when the minimum mu value is less than the threshold mu value. In an example embodiment, the threshold mu value may be predetermined and stored in the memory 220 of the controller 140. In some cases, the threshold mu value may be approximately 0.4, which may correspond closely to mu values associated with snow (approximately 0.3) and ice (approximately 0.1). Thus, responsive to the mu detection module 310 estimating the minimum mu value as being less than the threshold mu value, the use of the turn assist feature may be prohibited.

The minimum mu value may be defined differently in various example embodiments. For instance, in one embodiment, the minimum mu value may simply be the lowest of the local mu estimates at each of the wheels 180 of the vehicle 110 gathered by the mu detection module 310. Such an embodiment may assume that the entire vehicle 110 is on a homogeneous surface with the same or substantially similar coefficient of friction at each wheel, or that the vehicle 110 will be on a surface with the same or substantially similar coefficient of friction at each wheel. This embodiment may be more conservative than others because the mu estimate at any wheel may be less than the threshold value in order for the controller 140 to generate a blocking signal to block the turn assist feature accordingly.

In another example embodiment, the mu detection module 310 may estimate a local mu value at each of the front wheels 266 of the vehicle 110 and the minimum mu value may be the lowest of the local mu values at the front wheels 266. As mentioned above, when the turn assist feature is active, the front axle may deliver the power upon the demand of the operator 125, and thus the front wheels 266 may receive higher torque than the rear wheels. In such cases, the front wheels 266 may be more likely to slip before the rear wheels, and if the front wheels slip, then the controller 140 may generate a blocking signal to block the turn assist feature accordingly.

In other example embodiments, the mu detection module 310 may estimate a local mu value at each of the rear wheels of the vehicle and the minimum mu value may be the lowest of the local mu values of the rear wheels. In this regard, if one or both of the rear wheels' mu estimates fall below the threshold mu value but the none of the front wheels' mu estimates do, then the vehicle 110 may be passing through a section of the surface that may have low mu conditions. In such an example embodiment, the turn assist feature may not need to be prevented and/or deactivated immediately, since the wheel(s) may recover higher mu conditions again promptly. In this regard, the controller 140 may start a timer and monitor the specific wheel or wheels where the low mu estimate was detected for a set amount of time. If the wheel(s) recover(s) during the set amount of time, then the turn assist feature may remain on and/or ready to activate. If the wheel(s) do(es) not recover during the set amount of time, then the turn assist feature may be prevented and/or deactivated.

Preventing the turn assist feature from activating altogether may be accomplished by the controller 140 generating the blocking signal for the turn assist feature. In other words, if the turn assist feature is not already active when the mu detection module 310 estimates a minimum mu value below the threshold mu value, then the blocking signal may not allow the turn assist feature to activate at all. In an example embodiment, the blocking signal may be an inhibit flag that may prevent the activation of the turn assist feature for as long as the inhibit flag is “true” or “in place” or “on”. In some cases, the blocking signal may remain on for a predetermined duration of time after estimating the minimum mu value that is below the threshold mu value. This ensures that the turn assist feature cannot be activated until the predetermined duration of time has elapsed, or until the minimum mu value increases to be greater than the threshold mu value.

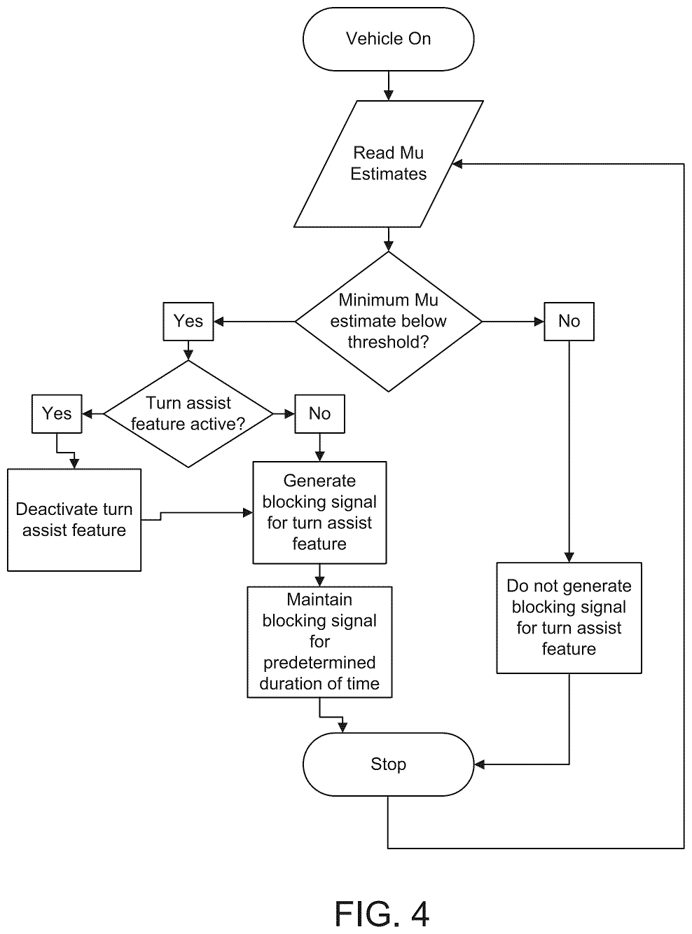

FIG. 4 depicts a flow chart representing an example embodiment of the decisions made by the mu detection module 310 and the controller 140. In the embodiment of FIG. 4, once the vehicle 110 is “on”, as in actively driving or ready to drive, the mu detection module 310 may calculate mu estimates and the controller 140 may read them accordingly. If the minimum mu estimate is not below the threshold mu value, then the controller 140 may take no action, nothing may prohibit the turn assist feature from activating and the controller 140 may continue to read mu estimates from the mu detection module 310. If the minimum mu estimate is below the threshold mu value, then whether or not the turn assist feature is already active may dictate the action taken by the controller 140. For instance, if the turn assist feature is not already active, the controller 140 may generate the blocking signal discussed above and may maintain the blocking signal for the predetermined duration of time. Once the predetermined duration of time has expired, nothing may prohibit the turn assist feature from activating and the controller 140 may continue to read mu estimates from the mu detection module 310 accordingly. If the turn assist feature is already active, however, then the blocking signal may deactivate or terminate the turn assist feature and the blocking signal may thus be maintained for the predetermined duration of time thereafter.

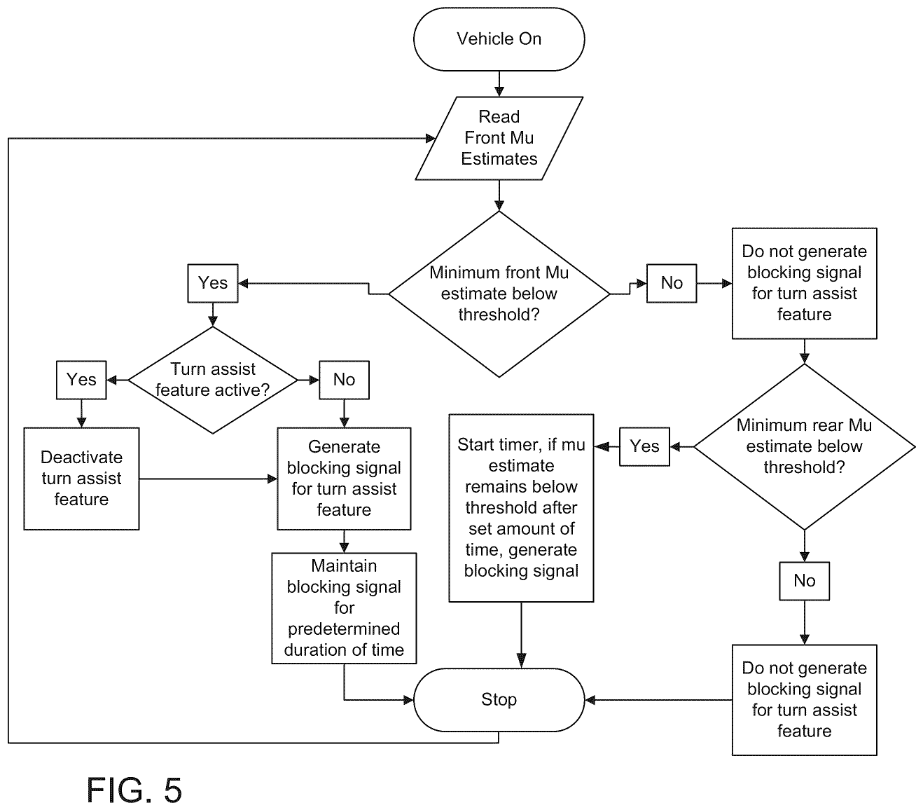

FIG. 5 also depicts a flow chart representing an example embodiment of the decisions made by the mu detection module 310 and the controller 140. In the embodiment of FIG. 5, once the vehicle 110 is “on”, as in actively driving or ready to drive, the mu detection module 310 may calculate mu estimates and the controller 140 may read them accordingly. If the minimum mu estimate is not below the threshold mu value, then the controller 140 may take no action, but prior to allowing the turn assist feature to activate, the controller 140 may then read the mu estimates from the rear wheels. If the minimum rear mu estimate is also not below the threshold mu value, then nothing may prohibit the turn assist feature from activating and the controller 140 may continue to read mu estimates from the mu detection module 310. However, if the minimum rear mu estimate is below the threshold mu value, then the controller may start the timer discussed above and monitor the rear wheels for the set amount of time to see if they recover higher mu conditions. If the rear wheels do recover higher mu conditions, then no action is taken and nothing may prohibit the turn assist feature. If the rear wheels do not recover higher mu conditions, then the blocking signal may be generated.

Similar to the embodiment of FIG. 4, in the embodiment of FIG. 5, if the minimum mu estimate is below the threshold mu value, then whether or not the turn assist feature is already active may dictate the action taken by the controller 140. For instance, if the turn assist feature is not already active, the controller 140 may generate the blocking signal discussed above and may maintain the blocking signal for the predetermined duration of time. Once the predetermined duration of time has expired, nothing may prohibit the turn assist feature from activating and the controller 140 may continue to read mu estimates from the mu detection module 310 accordingly. If the turn assist feature is already active, however, then the blocking signal may deactivate or terminate the turn assist feature and the blocking signal may thus be maintained for the predetermined duration of time thereafter.

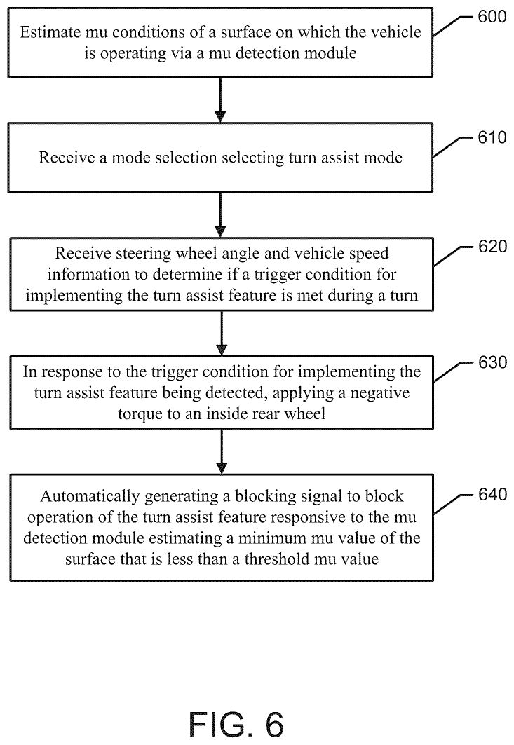

FIG. 6 illustrates a block diagram of one example method of providing automated application of turn radius reduction in a driver assist mode. The method may include estimating mu conditions of a surface on which the vehicle is operating via a mu detection module at operation 600. The method may further include receiving a mode selection selecting a turn assist mode at operation 610, and receiving steering wheel angle and vehicle speed information to determine if a trigger condition for implementing the turn assist feature may be met during a turn at operation 620. In response to a trigger condition for implementing the turn assist feature being detected, the method may further include applying a negative torque to an inside rear wheel at operation 630, and automatically generating a blocking signal to block operation of the turn assist feature responsive to the mu detection module estimating a minimum mu value of the surface that is less than a threshold mu value at operation 640.

Example embodiments may therefore also include a vehicle control system, which may include a mode selector including at least a turn assist mode selectable by an operator of the vehicle to activate a turn assist feature, a controller to employ the turn assist feature by directing application of braking torque to an inside rear wheel of the vehicle during a turn when a trigger condition for implementing the turn assist feature may be detected, and a mu detection module to estimate mu conditions of a surface on which the vehicle may be operating. The controller may further automatically generate a blocking signal to block operation of the turn assist feature responsive to the mu detection module estimating a minimum mu value of the surface that may be less than a threshold mu value.

The system of some embodiments may include additional features, modifications, augmentations and/or the like to achieve further objectives or enhance performance of the system. The additional features, modifications, augmentations and/or the like may be added in any combination with each other. Below is a list of various additional features, modifications, and augmentations that can each be added individually or in any combination with each other. For example, the mu detection module may continuously estimate the minimum mu value of the surface as the vehicle may be operating, both while the turn assist feature may be active and while the turn assist feature may not be active. In an example embodiment, the blocking signal may be configured to deactivate the turn assist feature responsive to the minimum mu value being below the threshold mu value while the turn assist feature may be active. In some cases, the blocking signal may be configured to prevent activation of the turn assist feature responsive to the minimum mu value being below the threshold mu value before the turn assist feature may be active. In an example embodiment, the blocking signal may remain on for a predetermined duration of time after estimating the minimum mu value that may be below the threshold mu value so that the turn assist feature cannot be activated until the predetermined duration of time has elapsed. In some cases, the mu detection module may estimate a local mu value at all wheels of the vehicle and the minimum mu value may be the lowest of the local mu values. In an example embodiment, the mu detection module may estimate a local mu value at front wheels of the vehicle and the minimum mu value may be the lowest of the local mu values. In some cases, the mu detection module may estimate a local mu value at rear wheels of the vehicle and the minimum mu value may be the lowest of the local mu values. In an example embodiment, responsive to the minimum mu value being below the threshold mu value, the blocking signal does not block operation of the turn assist feature until after monitoring the rear wheels for a set amount of time. In some cases, the trigger condition may include detecting a steering wheel angle being at a maximum angle that corresponds to a limit of rotation of a steering wheel, and detecting vehicle speed below a threshold speed.

In another example embodiment, a method of automatically controlling application of a turn assist feature in a vehicle is provided. The method may include estimating mu conditions of a surface on which the vehicle may be operating via a mu detection module, receiving a mode selection selecting a turn assist mode, receiving steering wheel angle and vehicle speed information to determine if a trigger condition for implementing the turn assist feature may be met during a turn, in response to the trigger condition for implementing the turn assist feature being detected, applying a negative torque to an inside rear wheel, and automatically generating a blocking signal to block operation of the turn assist feature responsive to the mu detection module estimating a minimum mu value of the surface that may be less than a threshold mu value.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. A vehicle control system, the system comprising:
a mode selector including at least a turn assist mode selectable by an operator of a vehicle to activate a turn assist feature;
a controller to employ the turn assist feature by directing application of braking torque to an inside rear wheel of the vehicle during a turn when a trigger condition for implementing the turn assist feature is detected; and
a mu detection module to estimate mu conditions of a surface on which the vehicle is operating,
wherein the controller further automatically generates a blocking signal to block operation of the turn assist feature responsive to the mu detection module estimating a minimum value of the surface that is less than a threshold mu value.

2. The system of claim 1, wherein the mu detection module continuously estimates the minimum mu value of the surface as the vehicle is operating, both while the turn assist feature is active and while the turn assist feature is not active.

3. The system of claim 1, wherein the blocking signal is configured to terminate the turn assist feature responsive to the minimum mu value being below the threshold mu value while the turn assist feature is active.

4. The system of claim 1, wherein the blocking signal is configured to prevent activation of the turn assist feature responsive to the minimum mu value being below the threshold mu value before the turn assist feature is active.

5. The system of claim 4, wherein the blocking signal remains on for a predetermined duration of time after estimating the minimum mu value that is below the threshold mu value so that the turn assist feature cannot be activated until the predetermined duration of time has elapsed.

6. The system of claim 4, wherein the mu detection module estimates a local mu value at all wheels of the vehicle and the minimum mu value is a lowest of the local mu values.

7. The system of claim 4, wherein the mu detection module estimates a local mu value at front wheels of the vehicle and the minimum mu value is a lowest of the local mu values.

8. The system of claim 4, wherein the mu detection module estimates a local mu value at rear wheels of the vehicle and the minimum mu value is a lowest of the local mu values.

9. The system of claim 8, wherein responsive to the minimum mu value being below the threshold mu value, the blocking signal does not block operation of the turn assist feature until after monitoring the rear wheels for a set amount of time.

10. The system of claim 1, wherein the trigger condition comprises detecting a steering wheel angle being at a maximum angle that corresponds to a limit of rotation of a steering wheel, and detecting vehicle speed below a threshold speed.

11. A method of automatically controlling application of a turn assist feature in a vehicle, the method comprising:
estimating mu conditions of a surface on which the vehicle is operating via a mu detection module;
receiving a mode selection selecting a turn assist mode;
receiving steering wheel angle and vehicle speed information to determine if a trigger condition for implementing the turn assist feature is met during a turn;
in response to the trigger condition for implementing the turn assist feature being detected, applying a negative torque to an inside rear wheel; and
automatically generating a blocking signal to block operation of the turn assist feature responsive to the mu detection module estimating a minimum mu value of the surface that is less than a threshold mu value.

12. The method of claim 11, wherein the mu detection module continuously estimates the minimum mu value of the surface as the vehicle is operating, both while the turn assist feature is active and while the turn assist feature is not active.

13. The method of claim 11, wherein the blocking signal is configured to terminate the turn assist feature responsive to the minimum mu value being below the threshold mu value while the turn assist feature is active.

14. The method of claim 11, wherein the blocking signal is configured to prevent activation of the turn assist feature responsive to the minimum mu value being below the threshold mu value before the turn assist feature is active.

15. The method of claim 14, wherein the blocking signal remains on for a predetermined duration of time after estimating the minimum mu value that is below the threshold mu value so that the turn assist feature cannot be activated until the predetermined duration of time has elapsed.

16. The method of claim 14, wherein the mu detection module estimates a local mu value at all wheels of the vehicle and the minimum mu value is a lowest of the local mu values.

17. The method of claim 14, wherein the mu detection module estimates a local mu value at front wheels of the vehicle and the minimum mu value is a lowest of the local mu values.

18. The method of claim 14, wherein the mu detection module estimates a local mu value at rear wheels of the vehicle and the minimum mu value is a lowest of the local mu values.

19. The method of claim 18, wherein responsive to the minimum mu value being below the threshold mu value, the blocking signal does not block operation of the turn assist feature until after monitoring the rear wheels for a set amount of time.

20. The method of claim 11, wherein the trigger condition comprises detecting a steering wheel angle being at a maximum angle that corresponds to a limit of rotation of a steering wheel, and detecting vehicle speed below a threshold speed.
